(19) United States
(12) Patent Application Publication
(10) Pub. No.: US 2009/0219809 A1
(43) Pub. Date: Sep. 3, 2009

(54) Redundant mux cnfiguration

(76) Inventors: Thomas A. Freeburg, St. Charles, IL (US); David Padgitt, Schaumburg, IL (US); Jonathan Wojtalik, Mt. Prospect, IL (US)

Correspondence Address: Paul E Schaafsma;NovuslP, LLC, Suite 221, 521 West Superior Street, Chicago, IL, 60610, US

(21) Appl. No.: 12/074,352

(22) Filed: Mar. 3, 2008

(51) Int. Cl. H04L 12/24; H04L 29/02; H04J 3/06; H04B 7/00

(52) U.S. Cl. 370/228; 370/464; 370/503; 370/310

(57) ABSTRACT

A system and method in accordance with the principles of the present invention prevents data from being permanently lost when external interference causes packet loss, and the interference is long enough in duration to cause adjacent packets to be lost. A data packet stream is transmitted. A redundant data packet stream also is transmitted so that any interference does not cause permanent packet loss, since either the original data packet stream or the redundant data packet stream arrives. In one embodiment, the redundant data packet stream is a delayed transmission. In another embodiment, the data packet stream is transmitted over one link and the redundant data packet stream is transmitted over another link. One implementation of the present invention includes a hybrid multiplexer and redundant communications links. When performance of one link degrades, the hybrid multiplexer switches the traffic to the other link.

### FIELD OF THE INVENTION

The invention relates generally to the wireless communication systems.

### BACKGROUND OF THE INVENTION

As is understood by one of ordinary skill, there is a fair body of art in the area of Time Division Multiplexing over Internet Protocol (TDMoIP), but the majority of that art is focused on Internet Protocol (IP) links that are carried over physical media, such as fiber, DSL, and coaxial cable, which are all quite different than wireless, which presents a variety of characteristics that are quite different from those of the physical media.

Many wide-band Internet Protocol (IP) radio systems today use the Time Division Duplex (TDD) method as known in the art. In a TDD system a common carrier is shared between the uplink and downlink, the resource being switched in time. Users are allocated one or more timeslots for uplink and downlink transmission. One major advantage of TDD operation is that it allows asymmetric flow, which is more suited to data transmission.

It is also common to couple a multiplexer such as is used for Time Division Multiplexing over IP (TDMoIP) to such an Internet Protocol (IP) radio system that uses Time Division Duplex (TDD). There is a variety of existing Plesiochronous Digital Hierarchy (PDH) (for instance T1/E1) to Ethernet multiplexers on the market. These devices are intended to pass Time Division Multiplex information over an Internet Protocol (IP) link. These devices have found a variety of uses, for instance in support of the large population of existing equipment designed to communicate over PDH links.

One emerging application involves replacing conventional terrestrial (wire or optical fiber) PDH links with broadband IP wireless links. Unfortunately, the wireless equipment and links in question are often designed to deliver reliability suited to ordinary Internet applications, normally at an availability level in the region of 99%—commonly referred to as “two nines.” In contrast, many of the applications, such as internal links for cellular telephone systems, are designed around link reliability in the region of 99.999%—commonly referred to as “five nines.”

There is already in the art a method to improve the reliability of the PDH connection provided by the multiplexer in this instance. This method consists of using a form of redundant transmission, commonly called “Forward Error Correction” (FEC), over the wireless IP link. FEC consists of making two copies of each packet generated by the multiplexer in response to the PDH traffic, with perhaps a digital coding algorithm used to link them. These copies are constructed according to the rules of digital error-correcting codes, so that the entire information stream may be reconstructed if any one packet is lost or distorted in the process of transmission over the wireless IP link. In order to minimize the impact of lost packets on the redundant transmission, the packets are not duplicated, but the data within the packets is duplicated. This can be seen schematically in FIG. 1.

A problem with this method is that when external interference causes packet loss, and the interference is long enough in duration to cause adjacent packets to be lost in both the Original and the Redundant Data Packet Streams, data can be permanently lost. This can be seen schematically in FIG. 2. What would therefore be desirable would be, when external interference causes packet loss and the interference is long enough in duration to cause adjacent packets to be lost, a method that prevents data from being permanently lost.

### SUMMARY OF THE INVENTION

A system and method in accordance with the principles of the present invention prevents data from being permanently lost when external interference causes packet loss, and the interference is long enough in duration to cause adjacent packets to be lost. A data packet stream is transmitted. A redundant data packet stream also is transmitted so that any interference does not cause permanent packet loss, since either the original data packet stream or the redundant data packet stream arrives. In one embodiment, the redundant data packet stream is a delayed transmission. In another embodiment, the data packet stream is transmitted over one link and the redundant data packet stream is transmitted over another link. One configuration implementation of the present invention includes a hybrid multiplexer and redundant communication links. When performance of one link degrades, the hybrid multiplexer switches the traffic to the other link.

### BRIEF DESCRIPTION OF THE DRAWINGS

FIG. 1 is a schematic of a redundant packet redundant transmission stream as known in the art.

FIG. 2 is a schematic of a redundant packet redundant transmission stream with interference as known in the art.

FIG. 3 is a block diagram of an example wireless communications system in accordance with the principles of the present invention.

FIG. 4 is a schematic of a time-shifted packet stream.

FIG. 5 is a schematic of a time-shifted packet stream with interference.

FIG. 6 is a schematic of a point-to-multipoint synchronization of data stream arrival.

FIG. 7 is a schematic of a point-to-point synchronization of data stream arrival.

FIG. 8 is a schematic of a wireless/wireline Redundant MUX in a BTS/BSC application.

### DETAILED DESCRIPTION OF AN EMBODIMENT OF THE INVENTION

Referring to FIG. 3, an example radio system is seen. A “master multiplexer” 13, a timing master radio 15, a timing slave radio 17, and a slave multiplexer 19 can be provided. The timing master radio 15 is connected to the master multiplexer 13 via for example an IP connection. The master multiplexer 13 receives signals from a “master” DS1 connection 21. The timing slave radio 17 is connected to the slave multiplexer 19 via, for example, an IP connection. The slave multiplexer 19 sends a signal over a DS1 connection 23. The timing master radio 15 and the timing slave radio 17 communicate over a wireless (radio) connection.

Using the TDD method, a single frequency channel can be assigned to both the transmitter and the receiver. Both the uplink (UL) and downlink (DL) traffic use the same frequency but at different times; in effect, TDD divides the data stream into frames and, within each frame, assigns different time slots to the forward and reverse transmissions. This allows both types of transmissions to share the same transmission medium (i.e., the same radio frequency), while using only the part of the bandwidth required by each type of traffic.

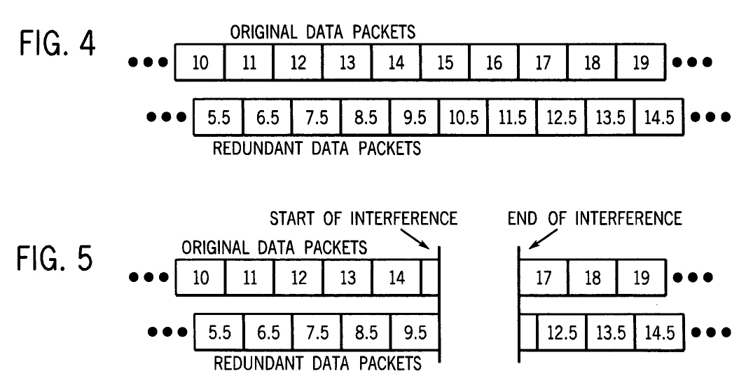

In accordance with the principles of the present invention, when external interference causes packet loss and the interference is long enough in duration to cause adjacent packets to be lost, data is prevented from being permanently lost. Referring to FIGS. 4 and 5, in one embodiment, transmission of the redundant data packet stream is delayed for a number of packets so that the interference would not cause permanent packet loss, since either the original data or the redundant data would arrive at the destination.

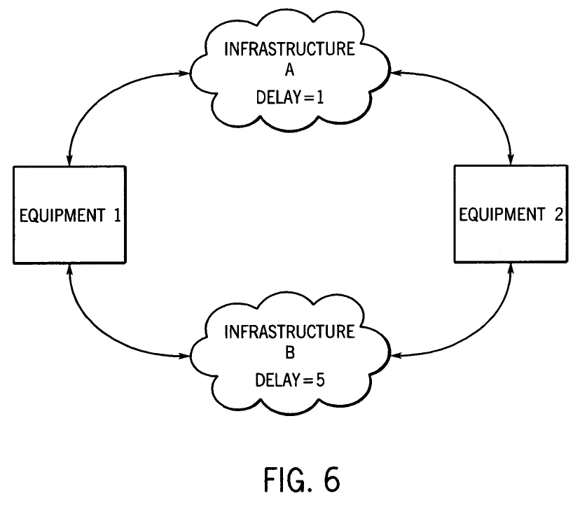

In another embodiment, one set of packets can be sent over one IP link, being directed out one IP port or via one IP address, and the other set of packets can be sent over a different IP link, which preferably is designed so that any errors the different IP link exhibits are uncorrelated with the errors in the first link, for instance by choosing a different geographical route. This can be seen in FIG. 6.

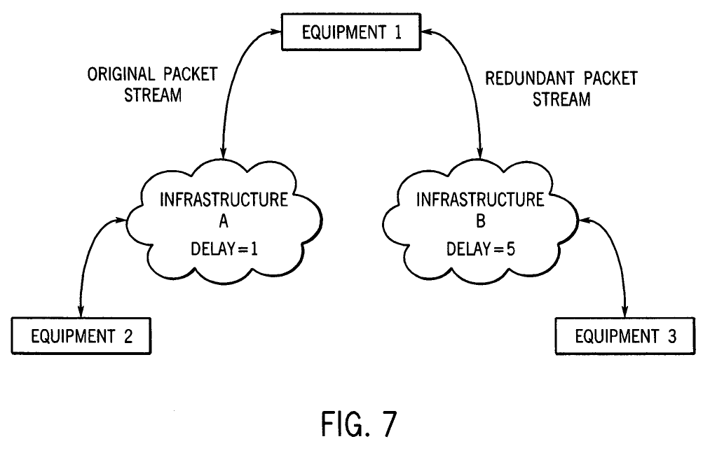

In addition to the case of interference, the time-shifted redundant packet streams can be used to synchronize the arrival of the two-data streams at the point of a remote piece of equipment. In other words, different paths through different infrastructure equipment have different delays: using the method of the present invention can allow the data streams that follow different infrastructure paths to arrive at the destination coincidentally. In a similar fashion, the present invention can be used to synchronize the arrival of data at two remote locations. This can be seen in FIG. 7.

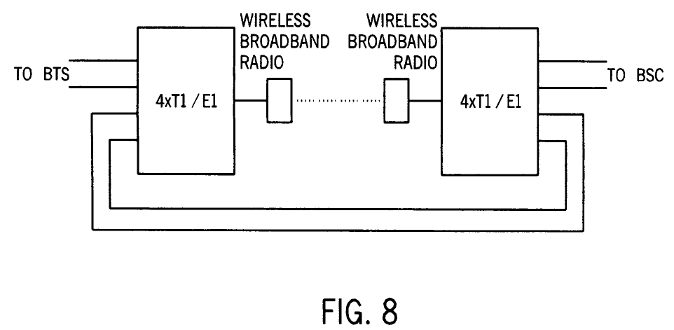

Referring now to FIG. 8, a configuration to implement the present invention can be seen. In this example, a hybrid multiplexer provides wired/wireless redundant T1/E1 communications links between, in the case of the cellular network example, backhaul between a BSC/RNC and a BTS/Node-B, via both wired T1/E1 links and a wireless broadband IP link. The FIG. 8 example shows such a system, utilizing two-multiplexed PDH streams over wireless broadband IP, and a pair of wired T1/E1 communication links. In this example, normal data transfer between the BTS and BSC occurs over the wired T1/E1 links at the bottom of the FIG. 8. When the performance of these links degrades to the point where the performance is unacceptable, the multiplexers switch the traffic to the wireless IP link over the broadband radio path. Thus, communication reliability is maintained regardless of the degradation of performance. Of course, the link may be maintained over the wireless broadband IP path, with failover to the wired link instead, at the choice of the system operator/installer.

There is yet another long-term benefit to this approach. By integrating such error statistics over time, the reliability of PDH-over-wireless-broadband IP (and/or the correlation between it and the wired T1/E1 communications links) can be documented. The utility of such a capability is that, for instance, a cellular carrier who has a long history of using wired T1/E1 communications links, but is inexperienced with using licensed or unlicensed broadband wireless IP, can add PDH over wireless IP to transport the carrier's backhaul for both redundancy; ultimately, should the collected statistics validate acceptable reliability of the wireless Ethernet data stream, the cellular carrier could replace the wired T1/E1 communications links with the wireless links, having verified the level of quality and realizing the cost savings.

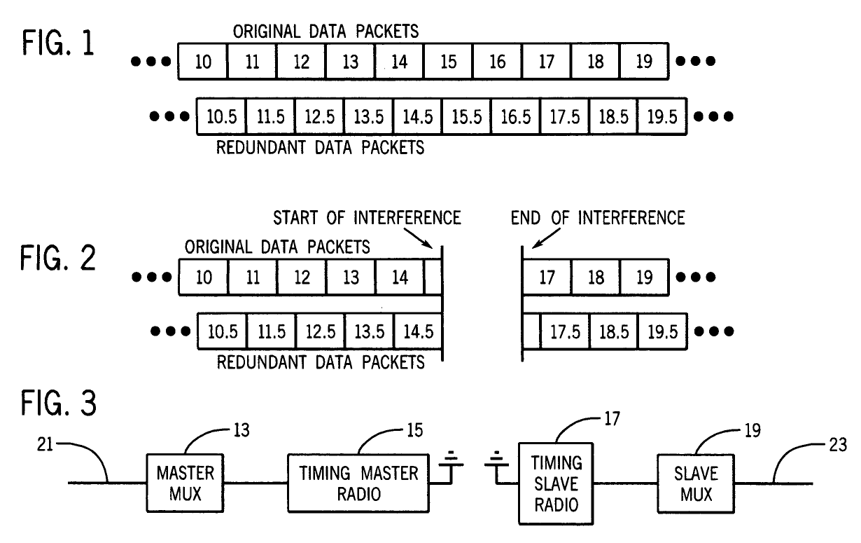

Of course, the configuration of FIG. 8 may be combined with the redundancy in FIG. 6 and/or FIG. 1, resulting in an even more reliable network.

While the invention has been described with specific embodiments, other alternatives, modifications and variations will be apparent to those skilled in the art. All such alternatives, modifications and variations are intended to be included within the spirit and scope of the appended claims.

What is claimed is:

1. A method of data transfer comprising:
transmitting a data packet stream; and
transmitting a redundant data packet stream such that either the original data packet stream or the redundant data packet stream or both arrives.

2. The method of data transfer of claim 1 further comprising delaying transmission of the redundant data packet stream.

3. The method of data transfer of claim 1 further comprising sending one data packet stream over one link and sending the redundant data packet stream over a different link.

4. The method of data transfer of claim 1 further comprising utilizing the redundant data packet stream to synchronize the arrival of the data packet streams at a remote site.

5. A method of data transfer comprising:
transmitting a data packet stream; and
transmitting a delayed redundant data packet stream such that either the original data packet stream or the redundant data packet stream or both arrives.

6. The method of data transfer of claim 5 further comprising delaying transmission of the redundant data packet stream for a number of packets.

7. The method of data transfer of claim 5 further comprising sending one data packet stream over one link and sending the redundant data packet stream over a different link.

8. The method of data transfer of claim 5 further comprising utilizing the redundant data packet stream to synchronize the arrival of the data packet streams at a remote site.

9. A method of data transfer comprising:
transmitting a data packet stream over one link; and
transmitting a redundant data packet stream over another link such that either the original data packet stream or the redundant data packet stream or both arrives.

10. The method of data transfer of claim 9 further comprising transmitting one data packet stream over one geographical route and transmitting the redundant data packet stream over a different geographical route.

11. The method of data transfer of claim 9 further comprising transmitting one data packet stream over one IP link and transmitting the redundant data packet stream over a different IP link.

12. The method of data transfer of claim 9 further comprising transmitting one data packet stream out one IP port and transmitting the redundant data packet stream out a different IP port.

13. The method of data transfer of claim 9 further comprising transmitting one data packet stream out one IP address and transmitting the redundant data packet stream out a different IP address.

14. The method of data transfer of claim 9 further comprising transmitting one data packet stream out one layer two MAC address and transmitting the redundant data packet stream out a different layer two MAC address.

15. The method of data transfer of claim 9 further comprising utilizing the redundant data packet stream to synchronize the arrival of the data packet streams at a remote site.

16. The method of data transfer of claim 9 further comprising delaying transmission of the redundant data packet stream.

17. A radio system comprising:
a hybrid multiplexer; and
redundant communications links, such that when performance of one link degrades, the hybrid multiplexer switches to the other link.

18. The radio system of claim 17 further wherein the redundant communications links comprise a wired link and a wireless link.

19. The radio system of claim 18 further wherein the redundant communications links comprise a wired T1/E1 link and a wireless broadband IP link.

20. The radio system of claim 18 further wherein when the performance of the wired link degrades, the hybrid multiplexer switch the traffic to the wireless link.

21. The radio system of claim 18 further wherein when the performance of the wireless link degrades to the point where the performance is unacceptable, the hybrid multiplexer switches the traffic to the wired link.
